(19) United States
(12) Patent Application Publication
(10) Pub. No.: US 2011/0025181 A1
(43) Pub. Date: Feb. 3, 2011

(54) PERSONAL STORAGE LOCKER

(75) Inventors: Bradley H. Vinke, Grand Valley (CA); David G. Laver, Hornings Mills (CA); Allan R. Holm, Aurora (CA); Michael A. Kling, Hartland, WI (US); Stephen L. Anderson, Rockton, IL (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: SPACESAVER CORPORATION, Fort Atkinson, WI (US)

(21) Appl. No.: 12/683,043

(22) Filed: Jan. 6, 2010

Related U.S. Application Data
(60) Provisional application No. 61/143,065, filed on Jan. 7, 2009.

(51) Int. Cl. A47B 47/00; B65D 55/14; E05B 65/44; A47B 88/04; H01R 33/00

(52) U.S. Cl. 312/257.1; 70/63; 70/78; 439/577

(57) ABSTRACT

A configurable personal storage locker having internal storage components that can be selectively removed and replaced depending upon user requirements. The personal storage locker includes spaced first and second side panels that each include internal hanging receivers that receive mounting tabs formed on the storage components. The storage components can be selectively placed at desired vertical heights within the storage locker to modify the internal configuration of the personal storage locker. Each personal storage locker includes a wiring bracket that allows the personal storage lockers to be daisy-chain connected to supply electrical power to each of the lockers while requiring only a single connection to an external power source. The personal storage locker can include a horizontal work surface that extends from the front edge of the personal storage locker and receives a drawer to provide additional enclosed storage space.

### CROSS-REFERENCE TO RELATED APPLICATION

The present application is based on and claims priority from U.S. Provisional Patent Application Ser. No. 61/143,065 filed on Jan. 7, 2009.

### BACKGROUND OF THE INVENTION

The present disclosure generally relates to a storage unit, such as a personal storage locker. More specifically, the present disclosure relates to a personal storage locker that can be easily configured for specific use by an individual locker occupant.

Personal storage lockers are typically positioned within a locker or dressing room for personnel, such as for use by military, police, fire departments, hospitals, schools and universities. Since the needs of the locker occupant can change and various different personnel may have different storage requirements, it is desirable that the individual personal storage lockers can be configured for each specific occupant. Further, since the needs of the locker occupants may change or the individual locker occupants may either be reassigned or moved to different locations within the facility, it is desirable that the personal storage locker can be easily configured.

Typically, multiple personal storage lockers will be positioned side-by-side to form a locker array or bank. Since a large number of lockers may be positioned adjacent to each other, it is desirable to be able to modify the configuration of each locker individually without requiring lockers to be removed from the bank.

### SUMMARY OF THE INVENTION

The present disclosure relates to a personal storage locker that can be configured for use by an individual locker occupant. The personal storage locker can be positioned in a side-by-side relationship to create a locker bank where each of the individual personal storage lockers can be readily configured based upon the occupants assigned to each locker.

The personal storage locker includes a locker frame having first and second side panels, a back panel and a top panel that extends between the first and second side panels to define an internal locker cavity. The interior surface of each of the spaced side panels include a series of spaced hanging receivers that allow various storage components to be selectively positioned within the locker cavity. Preferably, each of the storage components includes mounting tabs that are received in the hanging receivers such that the storage components can be easily moved and supported within the locking cavity through the interaction between the mounting tabs and the hanging receivers.

The individual storage components received and retained within the locker cavity can take many different forms, such as but not limited to a full length shelf, a weapons shelf, a locking drawer, a multiple hook bracket, a file shelf and hanging rod, a perforated shelf, a lower shelf including a rubber mat, a file storage component, a series of drawers and a modular cell unit having a locking door for securing valuable items. The individual storage components can be removed and replaced within any of the series of personal storage lockers positioned in the locker bank.

In one embodiment, the personal storage locker includes a drawer housing that is mounted to the lower end of the personal storage locker and extends from the spaced first and second side panels. The drawer housing includes a planar work surface and receives a drawer that can extend inward and outward relative to the side panels. The planar work surface can be used as a seat or bench by the locker occupant. The drawer is mounted for movement relative to the first and second side panels and the drawer housing and is received within the lower end of the personal storage locker in a retracted position.

In one contemplated embodiment, the personal storage locker includes a modular wiring system that is mounted to each of the personal storage lockers. The modular wiring system is received within a knockout formed in the personal storage locker and connects a receptacle of the wiring system to the electrical wiring contained within the personal storage locker. The receptacle of the modular wiring system is connected to a bracket having a series of connecting plugs. The connecting plugs of adjacent storage lockers can be electrically connected to each other such that electrical power can flow between adjacent lockers. One of the modular wiring systems is connected to a power supply to supply power to the entire locker bank. In this manner, only a single hardwire connection to the power supply is required for the entire locker bank.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of five personal storage lockers positioned next to each other and each uniquely configured for each locker occupant;

FIGS. 2A-2R are illustrations of alternate external configurations for the personal storage locker of the present disclosure;

FIG. 3 is an exploded view of the lockers shown in FIG. 1 illustrating the different components mounted within the individual lockers;

FIG. 4A is an exploded view showing the mounting of a large, perforated shelf at a desired horizontal storage location;

FIG. 4B illustrates the specific mounting configuration used to secure the items within the storage locker;

FIG. 4C is an exploded view of one type of component mounted within the personal storage locker;

FIG. 4D is a magnified view of a mounting hook;

FIG. 5A is a perspective view of the personal storage locker including an extended bench and drawer;

FIG. 5B is an exploded view of the personal storage locker configured as shown in FIG. 5A; and

FIG. 6 is a partial perspective view illustrating the electrical connections between adjacent personal storage lockers.

### DETAILED DESCRIPTION OF THE INVENTION

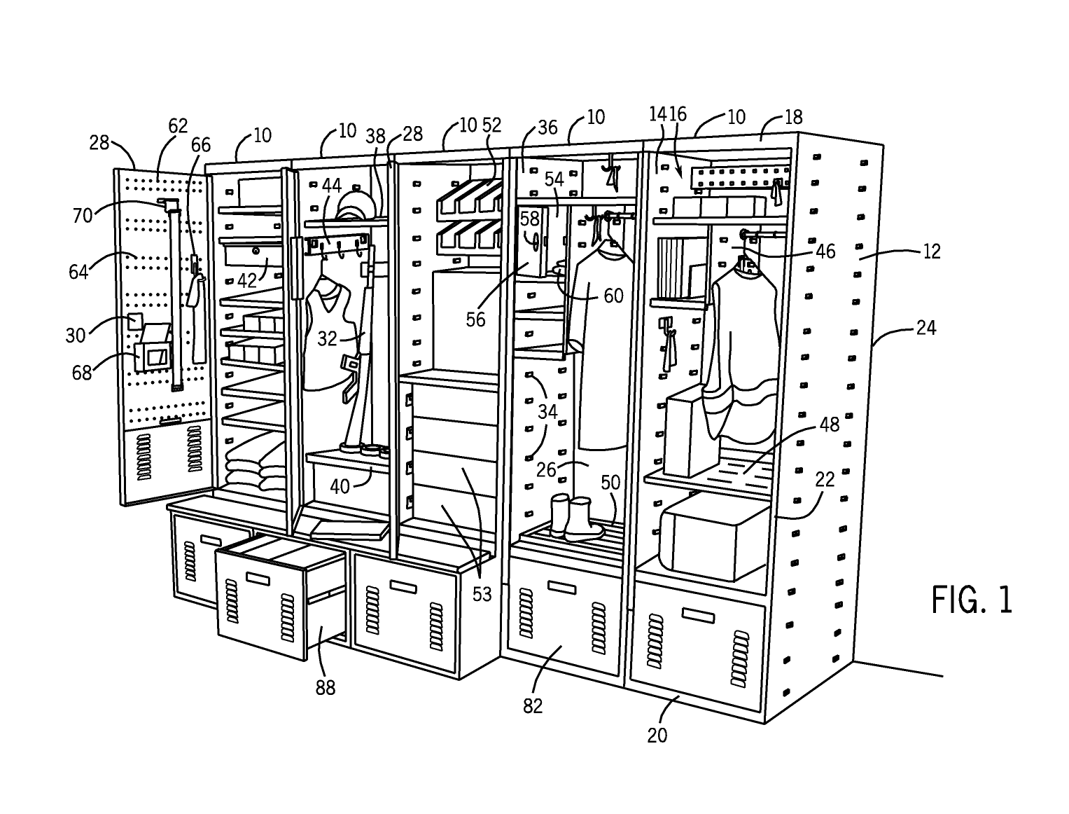

FIG. 1 illustrates a plurality of individual personal storage lockers 10 positioned side-by-side to form a locker array or bank. Each of the individual personal storage lockers 10 is formed from a first side panel 12 and a second side panel 14 that are spaced from each other to define a generally open locker cavity 16. In the embodiment of FIG. 1, the locker cavity 16 is defined at an upper end by a top panel 18 and at a lower end by a bottom panel 20. Each of the personal storage lockers 10 extends from a front edge 22 to a back edge 24 that are each defined by surfaces of the spaced side panels 12, 14. In the embodiment shown in FIG. 1, a back panel 26 is connected to the back edge 24 to close the back portion of the locker cavity 16. However, it should be understood that the back panel 26 could be eliminated when the series of personal storage lockers 10 are mounted to a wall, in which the wall would enclose the back of the locker cavity 16.

As illustrated in FIG. 1, the first three personal storage lockers 10 on the left each include a door 28 that can selectively close the locker cavity 16. Each door 28 can include a locking mechanism 30 that engages a latch formed on the side panel 12 such that the equipment and personal items stored within the locker cavity 16 can be secured. In the embodiment shown in FIG. 1, the locker bank formed by the series of personal storage lockers 10 are utilized by a military unit and may be used to store firearms 32 and other dangerous equipment such that the locking mechanisms 30 provides for additional security.

The first and second side panels 12, 14 of each of the personal storage lockers 10 includes a series of hanging receivers 34 that extend from the inner surface 36. As illustrated in FIG. 1, the hanging receivers 34 are configured in spaced pairs at various different vertical heights along the spaced first and second side panels 12, 14. The hanging receivers 34 allow various different storage components to be selectively positionable within the locker cavity. Throughout the remaining disclosure, the term “storage component” is meant to refer to the various types of storage devices that can be removably mounted within the locker cavity. As an illustrative example, the five personal storage lockers 10 illustrated in FIG. 1 include a full length shelf 38, a weapons shelf 40, a locking drawer 42, an adjustable three hook bracket 44, a combined file shelf and hanging rod 46, a perforated shelf 48, a lower shelf including a rubber mat 50, bin storage component 52, a series of drawers 53 and a modular cell unit 54 having a door 56 with a separate locking member 58 that can secure items 60 within an internal lockbox formed within the locker cavity 16. Various other storage components can be utilized while operating within the scope of the present disclosure. As will be understood by the description below, the hanging receivers 34 allow the various different storage components to be selectively positioned and removed from within the locker cavity 16. The configurability of the personal storage lockers 10 allows each of the lockers 10 to be configured for the specific occupant.

In the embodiment shown in FIG. 1, the interior surface 62 of the door 28 includes a series of mounting holes 64 that allow various components, such as mounting hooks 66, a document holder 68 and a mounting clip 70 to be selectively positioned along the interior surface 62. Once again, the series of mounting holes 64 allow each of the personal storage lockers 10 to be selectively configured for the specific personnel utilizing the locker.

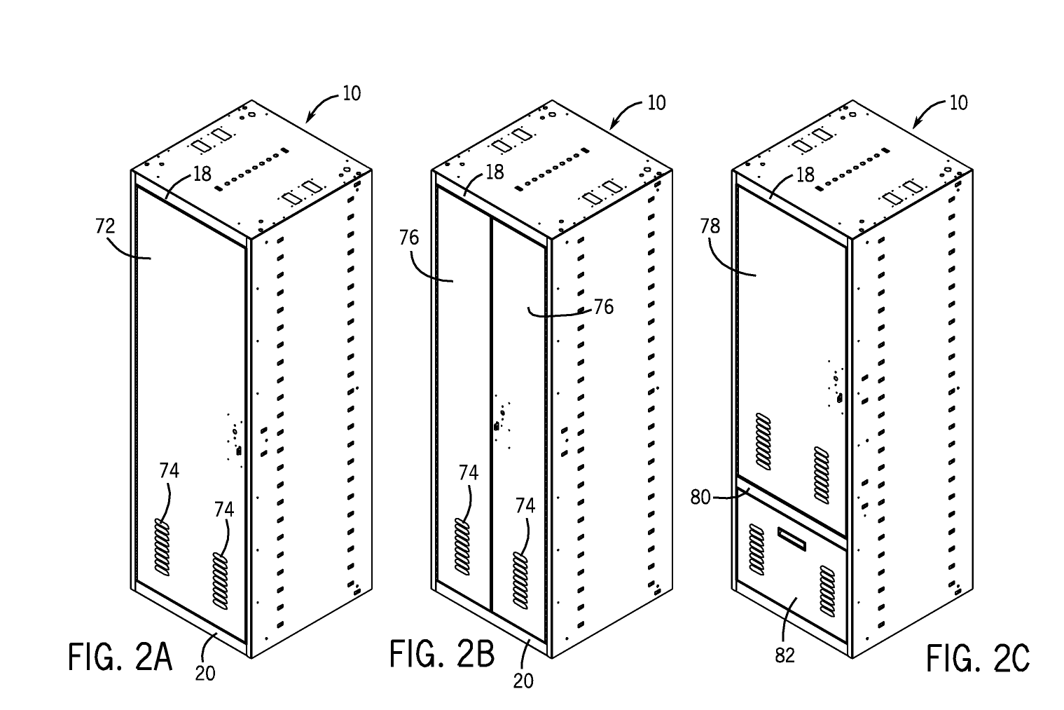

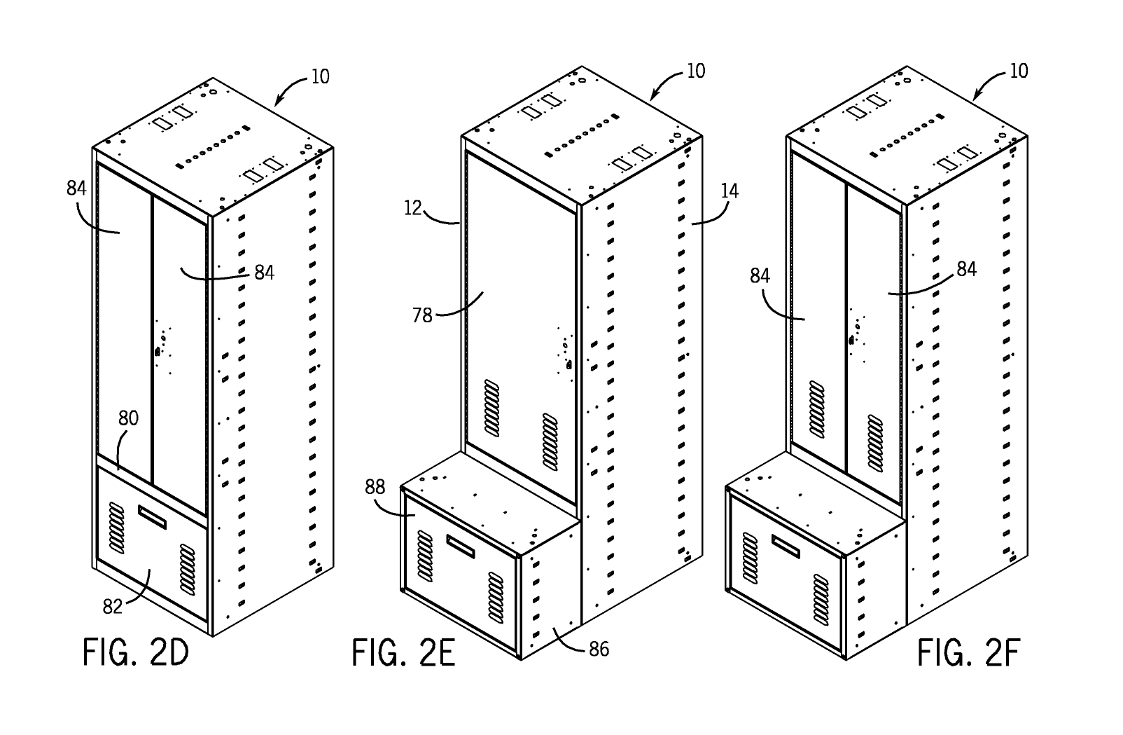

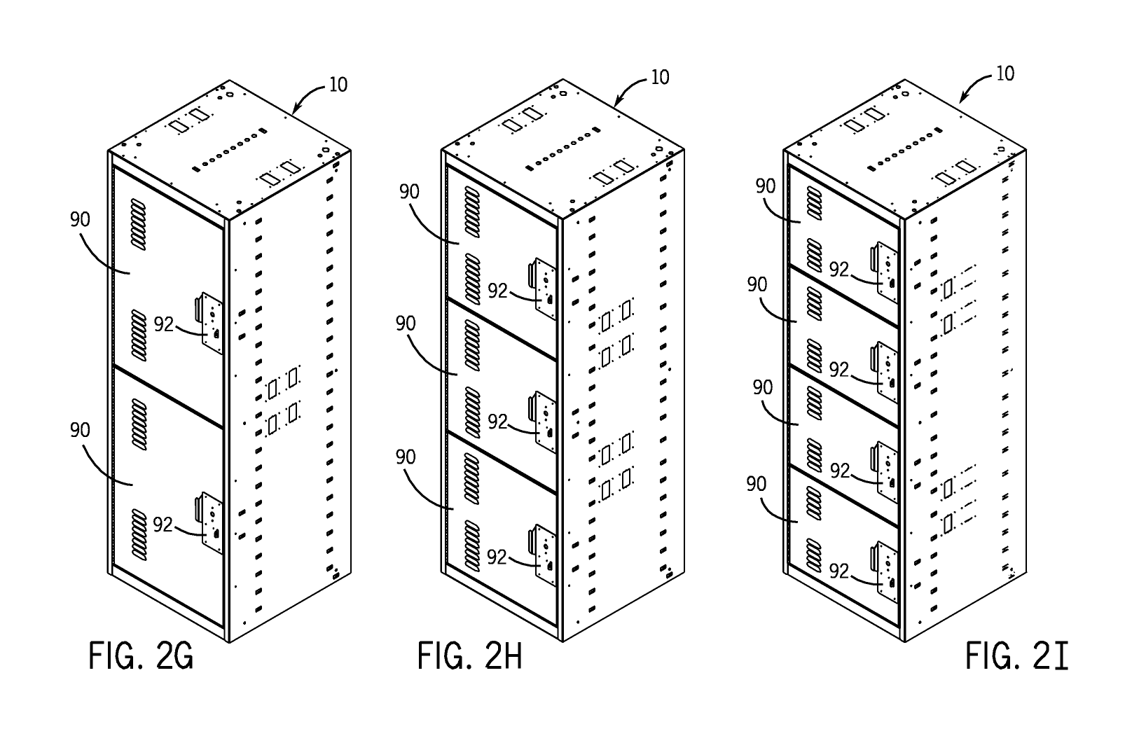

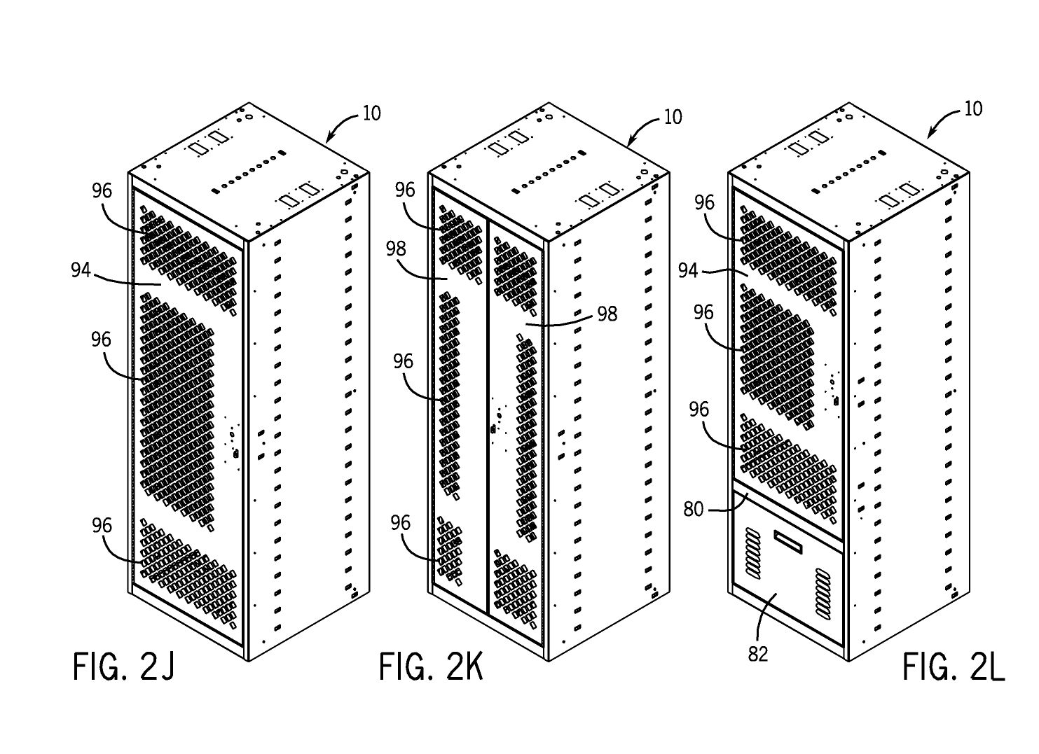

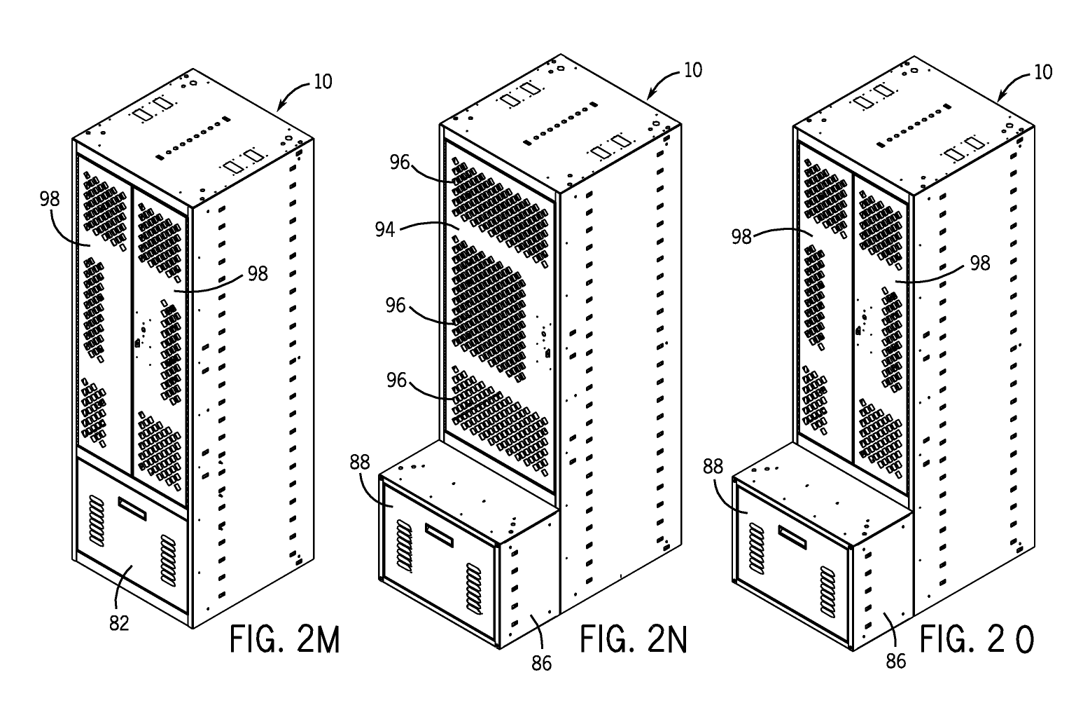

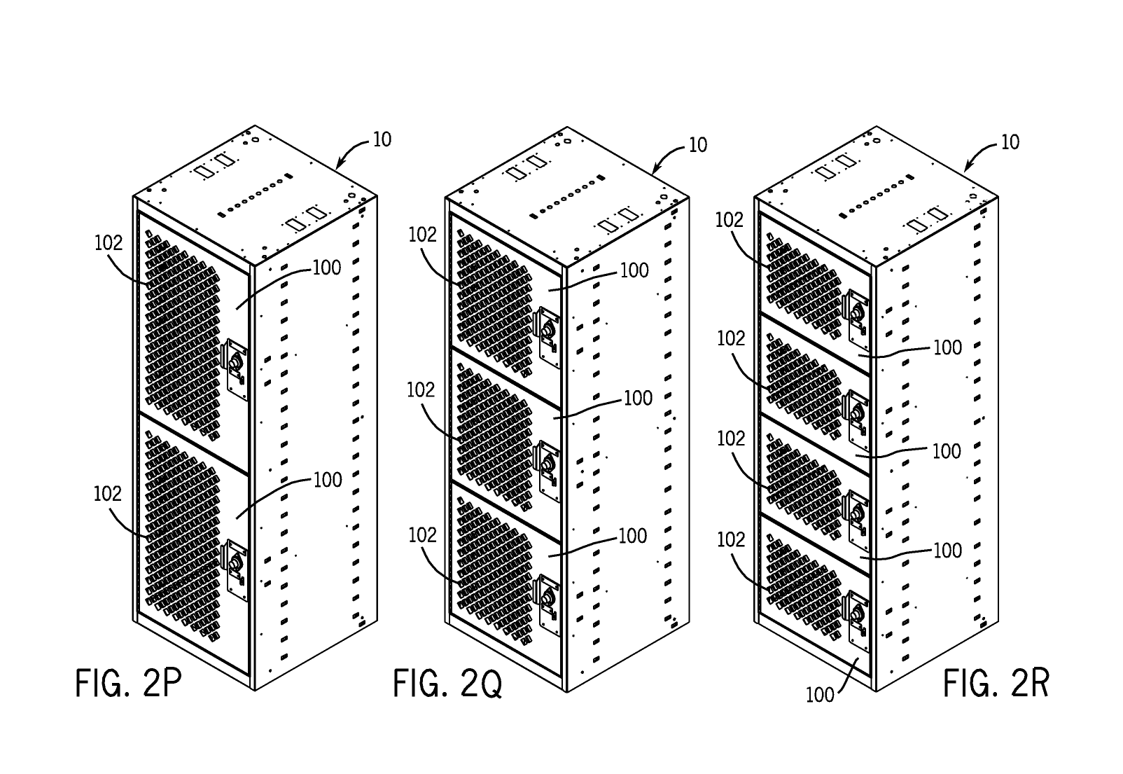

In addition to the various internal configurations possible, FIGS. 2A-2R generally disclose various different external configurations for the personal storage locker 10. Although these Figures show different configurations for the exterior of the personal storage locker 10, it should also be understood that in addition to the external configurations, the internal configuration of the locker cavity for each personal storage locker can also be configured in an infinite number of manners depending upon the specific locker occupant.

FIG. 2A illustrates an embodiment in which the personal storage locker 10 includes a single door 72 that extends the entire height of the locker 10 from the top panel 18 to the bottom panel 20. The door 72 includes a series of ventilation openings 74, as illustrated.

FIG. 2B illustrates a configuration for the personal storage locker 10 in which the locker includes a pair of side-by-side opening doors 76 that also extend from the top panel 18 to the bottom panel 20. Each door 76 also includes vents 74.

FIG. 2C illustrates an embodiment of the personal storage locker having a door 78 that extends from the top panel 18 to a lower support shelf 80. A drawer 82 is mounted beneath the lower support shelf 80.

FIG. 2D is similar to the embodiment of FIG. 2C except that the single door 78 is replaced by a pair of doors 84.

FIG. 2E illustrates an embodiment in which a drawer housing 86 is positioned at the lower end of the personal storage locker 10. In this embodiment, a drawer 88 extends through both the drawer housing 86 and the lower portion of the locker cavity defined by the spaced side panels 12, 14.

FIG. 2F is similar to the embodiment of FIG. 2E except that the single door 78 is replaced by the pair of adjacent doors 84.

FIG. 2G illustrates an embodiment in which the personal storage locker 10 is configured to have a locking upper compartment and a locking lower compartment. The upper and lower compartments are each accessed through a locking door 90. In such an embodiment, different individuals could share a single personal storage locker 10 and have access to only their locker through the locking mechanism 92 formed on each of the doors 90.

FIG. 2H is similar to FIG. 2G except that the personal storage locker 10 is configured to define three separate locking compartments each having a separate door 90 and locking mechanism 92.

FIG. 2I illustrates an embodiment having four separate locking compartments each having their own door 90 and locking mechanism 92.

FIG. 2J is similar to FIG. 2A except that the door 94 includes enhanced ventilation areas 96. The enhanced ventilation areas 96 allows clothing and other equipment contained within the personal storage locker 10 to dry quicker as compared to the embodiment of FIG. 2A. Additionally, the ventilation areas 96 allow the contents of the locker 10 to be viewed when the door 94 is closed. This feature is particularly desirable when locker inspection is required as part of training, such as in the military.

FIG. 2K is similar to FIG. 2J except that the single door 94 is replaced by a pair of doors 98 each having the enhanced ventilation areas 96.

FIG. 2L illustrates an embodiment having the door 94 with the enhanced ventilation areas 96 and utilized with the drawer 82 similar to FIG. 2C.

FIG. 2M is similar to the embodiment of FIG. 2I except that the single door 94 has been replaced by the pair of doors 98.

FIG. 2N illustrates an embodiment similar to FIG. 2E in which the drawer housing 86 is mounted to the lower end of the locker 10.

FIG. 2O is similar to the embodiment of FIG. 2N except that the single door 94 is replaced by the pair of doors 98.

FIG. 2P illustrates an embodiment similar to FIG. 2G except that the doors 90 have been replaced by doors 100 having enhanced ventilation areas 102.

FIG. 2Q is similar to the embodiment of FIG. 2H in which the doors 100 include the enhanced ventilation areas 102.

FIG. 2R is similar to the embodiment of FIG. 2I in which the doors 100 also include the enhanced ventilation areas 102.

As can be understood by the various embodiments shown in FIGS. 2A-2R, the personal storage locker 10 can be configured with many different external configurations, including the number of doors, type of ventilation in the doors, and the use of a storage drawer near the lower end of the locker 10. Further, various different locking mechanisms can be utilized with the doors, as shown. In addition to these embodiments, FIG. 1 also illustrates that each of the personal storage lockers could be configured without having any door and providing easy access to the locker cavity. In each of the embodiments, the side panels 14, 16 remain in the same position and each include the hanging receivers 34 that allow the internal components to be mounted as described. Thus, the personal storage locker system can be selectively configured both from an external perspective and internally within the locker cavity as desired by the occupant of the personal storage locker 10.

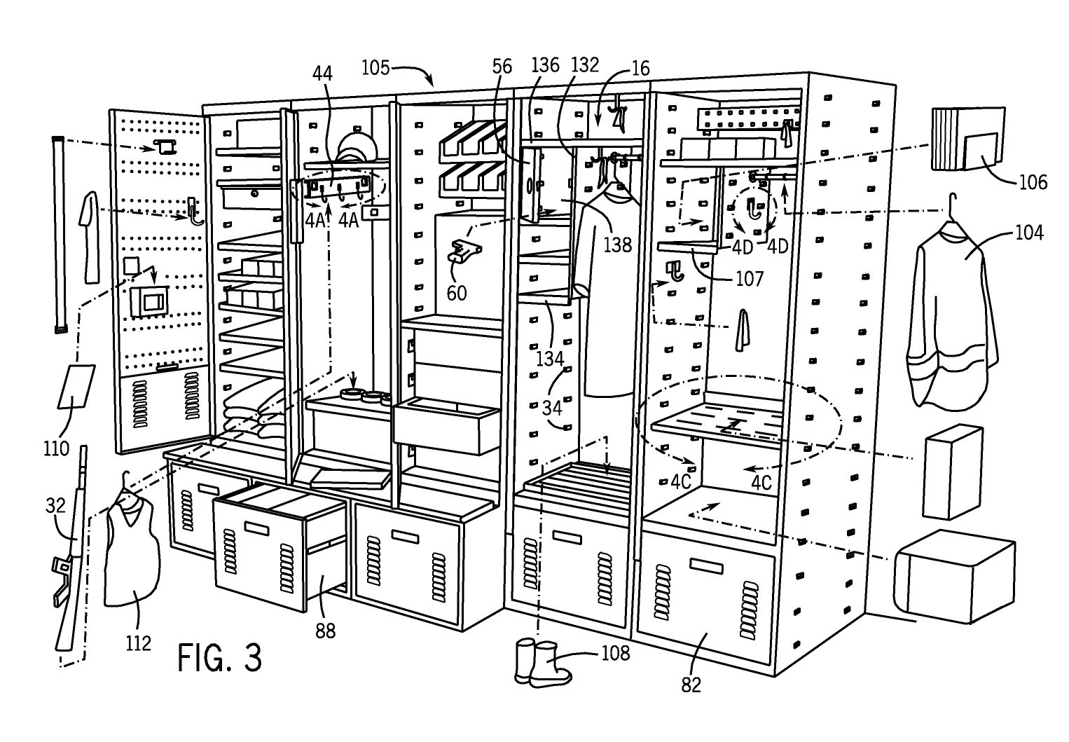

FIG. 3 illustrates the locker system 105 having many of the items stored within the locker removed from the positioned storage components. These personal articles of the locker occupant can include uniforms 104, a file divider 106, footwear 108, documents 110, body armor 112, firearms 32 and 60, as well as various different pieces of clothing, as illustrated. The file divider 106 is received on a shelf 107 having divider slots for receiving the divider 106. In the embodiment of FIG. 3, each of the personal storage lockers 10 includes a drawer 82 or 88 that can be retracted and extended from within the lower end of the personal storage locker 10. As previously described, the various different storage components that can be supported within the locker cavity are each supported by the hanging receivers 34.

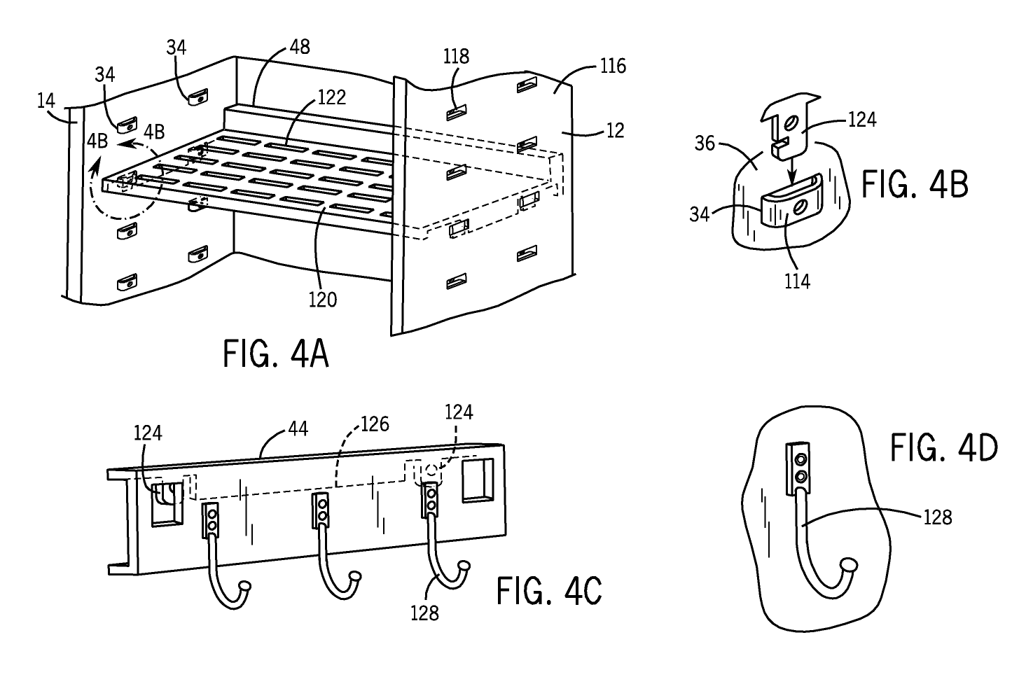

FIGS. 4A and 4B provide additional details for the configuration of the hanging receivers 34. As illustrated in FIG. 4B, each of the hanging receivers 34 includes a protruding wall 114 that extends from the generally planar inner surface 36. In the embodiment shown in FIGS. 4A and 4B, the curved wall 114 is stamped from the otherwise generally planar outer surface 116 to create an opening 118.

In FIG. 4A, the perforated shelf 48 is shown mounted between the side panels 12, 14. The perforated shelf 48 includes a generally planar support surface 120 that includes a series of ventilation openings 122. The side edge of the support surface 120 includes a series of mounting tabs 124 each received within one of the hanging receivers 34. As can be understood in FIGS. 4A and 4B, the perforated shelf 48 is positioned between the pair of spaced side panels 12, 14 and lowered until the mounting tabs 124 are received in the corresponding hanging receivers 34. When the perforated shelf 48 is to be removed, the perforated shelf 48 is lifted upward to remove the mounting tabs 124 from the hanging receivers 34. In a similar manner, various different storage components can be easily positioned within the personal storage lockers 10.

FIG. 4C illustrates the three hook bracket 44. The three hook bracket 44 also includes a pair of mounting tabs 124 formed on a back flange 126. As described, each of the mounting tabs 124 are received within one of the hanging receivers 34 to support the three hook bracket 44, as described. The three hook bracket 44 includes the series of mounting hooks 128, as shown in FIGS. 4C and 4D. Although mounting hooks 128 are shown, it should be understood that various other components could be mounted to the bracket 44 to support clothing or other equipment within the personal storage locker 10.

As can be understood in FIGS. 4A and 4B, the interaction between the mounting tabs 124 and the hanging receivers 34 allow the storage components to be selectively supported and removed from within the locker cavity. It is contemplated that each of the storage components contained within the locker cavity will include similar mounting tabs 124 that are received within the hanging receivers 34. In this manner, various storage components, such as shelves, drawers, hanging rods and lockboxes can be selectively positioned and removed from within the locker cavity.

Referring back to FIG. 3, the locker cavity 16 may also be provided with one or more modular cell units 54. The modular cell unit 54 includes an upright divider 132 and one or more shelf members 134 that are connected to the upright divider 132, preferably by one or more spot welds. In this regard, the upright divider 132 and the shelf members 134 form a single structure or subassembly that can be loaded as one unit into the locker interior. The cell unit 54 includes a top shelf 136 includes a pair of mounting tabs (not shown) on each end that are received within the hanging receivers 34. The mounting tabs are drop loaded into a pair of the hanging receivers 34. Thus, when the top shelf 136 is secured within the locker, the entire modular cell unit 54 is secured as one component.

In the embodiment shown in FIG. 3, the modular cell unit 54 includes a lockbox 138 having the door 56 including the locking member 58. In this manner, the lockbox 138 can be used to secure various items 60, such as a firearm. The locking member 58 is separate form the lock for the door to provide additional security for the firearm stored within the lockbox 138.

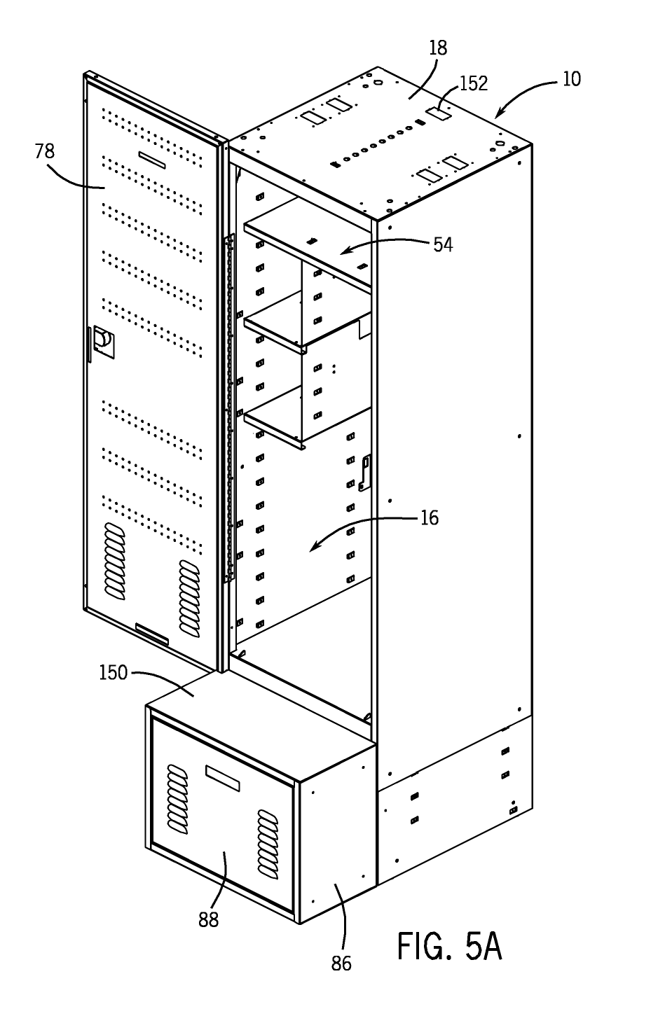

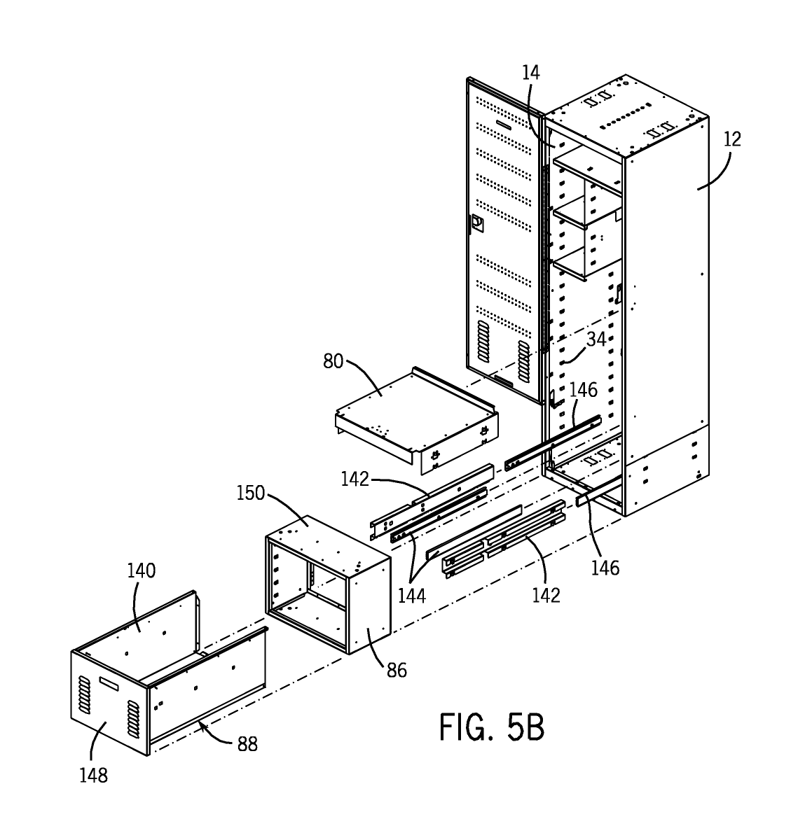

FIG. 5A illustrates the embodiment shown in FIG. 2E with the door 78 in an open position. As illustrated, the locker cavity 16 includes the modular cell unit 54 as previously described. The personal storage locker 10 further includes drawer 88. The specific configuration of the drawer 88 and the drawer housing 86 will now be described with reference to FIG. 5B.

As illustrated in FIG. 5B, the lower support shelf 80 is initially mounted within the locker cavity through the interaction between a series of mounting tabs formed on the lower support shelf and the hanging receivers 34. The drawer 88 includes a box 140 that is mounted to slide mounts 142. Drawer slides 144 are connected to the slide mounts 142 and are adapted to slide along the slides 146, which are mounted to the side panels 12, 14 by a series of brackets. Drawer 88 has a front face 148 that is generally flush against the drawer housing 86 when the drawer 88 is in the fully retracted position. The drawer housing 88 allows the drawer box 140 to have a depth that is greater than the depth of the side panels 12, 14. Instead, the drawer box 140 has a depth that is generally equal to the depth of the side panels 12, 14 and the depth of the drawer housing 86.

Drawer housing 86 defines a generally planar work surface 150 that the locker occupant may use as desired. As an example, the work surface 150 can be used as a foot rest or a seat, or to support other personal items when the locker is in use.

As illustrated in FIG. 5A, the top panel 18 includes a knockout 152 that can be removed to provide access to the electrical wiring contained within the personal storage locker. The electrical wiring contained within the personal storage locker allows power to be supplied to the personal storage locker 10 to allow the occupant to charge one or more electrical or electronic devices within the locker, such as shavers, radios, mobile or cellular phones, notebook computers, GPS devices, etc. Further, the power supplied to the personal storage locker 10 allows the locker to include ventilation fans, lights or other electrical devices.

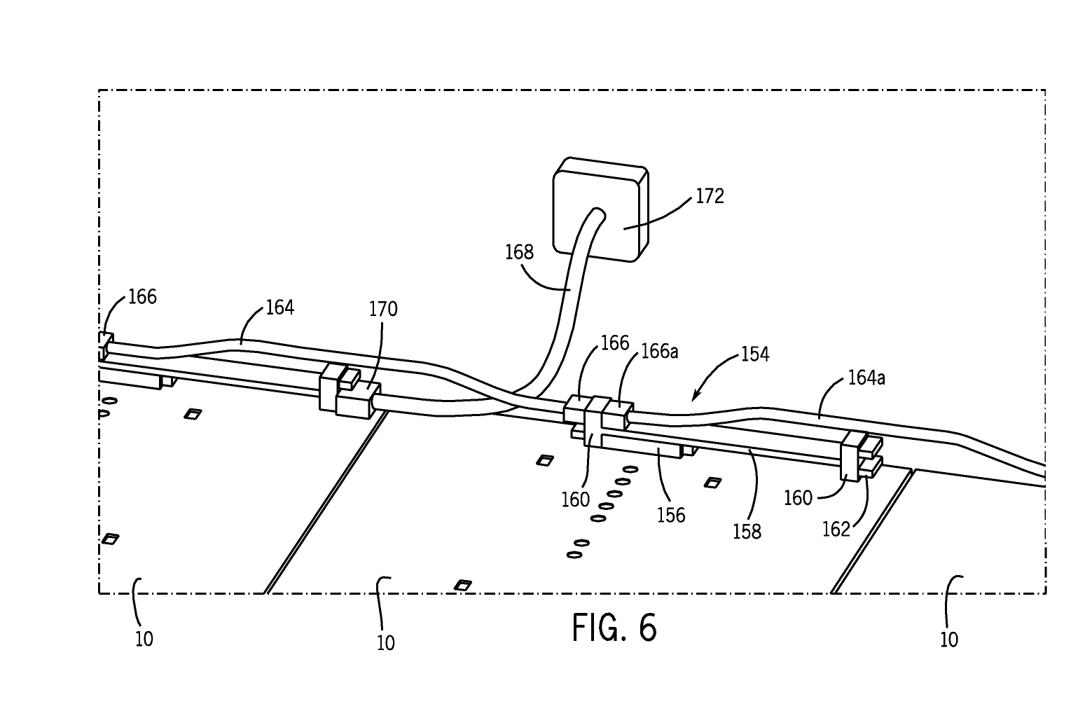

FIG. 6 illustrates the modular wiring system 154 utilized between the series of personal storage lockers 10 mounted in a side-by-side relationship. Each of the individual personal storage lockers 10 includes a duplex receptacle 156 that connects to the electrical wiring of the personal storage lockers through the knockout previously described. The duplex receptacle 156 is connected to a mounting bracket 158 having a pair of spaced mounting blocks 160. Each of the mounting blocks 160 includes a series of female and male connectors 162. The series of male and female connectors 162 allows the series of adjacent personal storage lockers 10 to be electrically connected to each other.

As illustrated, a connecting wire 164 extends between adjacent personal storage lockers 10 and includes a plug 166 on each end. Likewise, a second connecting wire 164A also including plug 166A connects the next two personal storage lockers 10.

A main power supply wire 168 having plug 170 extends to a power supply connection 172 to provide power for the entire bank of lockers connected utilizing the modular wiring system 154. In this manner, power can be connected to the bank of lockers utilizing only a single wire connection to the main power supply 172. The use of the plug connections between adjacent lockers eliminates the need for an electrician to provide a power connection to each individual locker, as was previously required in previously available embodiments.

We claim:

1. A selectively configurable personal storage locker comprising:
a locker frame including first and second side panels and a top panel extending between the first and second side panels to define an interior locker cavity, wherein each of the side panels includes a plurality of hanging receivers; and
a plurality of storage components selectively positionable within the locker cavity, wherein each of the storage components are supported within the locker cavity by the hanging receivers.

2. The personal storage locker of claim 1 wherein at least one of the storage components includes a locking door mounted to a self-contained lock box, wherein the self-contained lockbox is supported within the locker cavity.

3. The personal storage locker of claim 1 wherein at least one of the storage components is a shelving unit having a plurality of hanging tabs that interface with the hanging receivers to support the shelving unit within the locker cavity.

4. The personal storage locker of claim 3 wherein the shelving unit includes a shelf surface having a plurality of perforations to permit air flow therethrough.

5. The personal storage locker of claim 1 further comprising a locker door mounted to one of the side panels and configured to close the locker cavity.

6. The personal storage locker of claim 1 further comprising a drawer housing mounted to a lower end of the personal storage locker and extending from the first and second side panels, the drawer housing including a generally planar work surface that extends outward from the first and second side panels.

7. The personal storage locker of claim 6 further comprising a drawer mounted for movement relative to both the first and second side panels and the drawer housing.

8. The personal storage locker of claim 7 wherein an interior volume of the drawer is concealed within the drawer housing and the locker cavity when the drawer is in a retracted position.

9. The personal storage locker of claim 1 further comprising:
a lower support shelf mounted between the first and second side panels; and
a drawer mounted for movement relative to both the first and second side panels and positioned beneath the lower support shelf, wherein when the drawer is in a retracted position, an interior volume of the drawer is concealed by the first and second side panels and the lower support shelf.

10. The personal storage locker of claim 5 wherein an interior surface of the locker door includes a plurality of perforations that selectively receive one or more hanging elements.

11. A personal storage locker system comprising:
a plurality of individual personal storage lockers positioned in a side-by-side relationship to each other; and
a modular wiring system mounted to each of the personal storage lockers, the modular wiring system including a receptacle connected to the personal storage locker and at least a pair of connecting plugs,
wherein the modular wiring system of one of the plurality of personal storage lockers is connected to a power supply and the modular wiring system of each of the plurality of personal storage lockers are electrically connected to each other.

12. The personal storage locker system of claim 11 wherein the receptacle of each modular wiring system is received in a knockout formed in the personal storage locker.

13. The personal storage locker system of claim 11 wherein the personal storage lockers are electrically connected by a series of connecting wires that are each received in one of the plugs of adjacent personal storage lockers.

14. The personal storage locker system of claim 11 wherein each of the modular wiring systems is mounted to a top surface of the personal storage locker such that the plurality of personal storage lockers can be electrically connected to each other.

15. A personal storage locker system comprising:
a plurality of individual personal storage lockers positioned in a side-by-side relationship to each other, each personal storage locker including a locker frame including first and second side panels and a top panel extending between the first and second side panels to define an interior locker cavity, wherein each of the side panels includes a plurality of hanging receivers;
a plurality of storage components selectively positionable within the locker cavity of each of the plurality of individual personal storage lockers, wherein each of the storage components are supported within the locker cavity by the hanging receivers; and
a modular wiring system mounted to each of the personal storage lockers, wherein each of the modular wiring systems includes a receptacle connected to the personal storage locker and at least a pair of connecting plugs,
wherein the modular wiring system of one of the plurality of personal storage lockers is connected to an external power supply and the modular wiring systems of the plurality of personal storage lockers are electrically connected to each other.

16. The personal storage locker system of claim 15 wherein at least one of the personal storage lockers includes a drawer housing mounted to a lower end of the personal storage locker and extending from the first and second side panels, the drawer housing including a generally planar work surface that extends outward from the first and second side panel.

17. The personal storage locker system of claim 16 further comprising a drawer mounted for movement relative to both the first and second side panels and the drawer housing.

18. The personal storage locker system of claim 15 wherein the personal storage lockers are electrically connected to each other by a series of connecting wires that are each received in one of the plugs of the adjacent personal storage locker.

19. The personal storage locker system of claim 15 wherein at least one of the storage compartments includes a lock box having a locking door.

20. The personal storage locker system of claim 15 wherein the receptacle of each modular wiring system is received in a knockout formed in the personal storage locker.
